(19) United States
(12) Patent Application Publication
(10) Pub. No.: US 2023/0144880 A1
(43) Pub. Date: May 11, 2023

(54) APPARATUS AND SYSTEMS FOR PLANT CULTIVATIONS

(71) Applicant: Hexo Operations Inc., Gatineau (CA)

(72) Inventor: Richard Redekop, Gatineau (CA)

(21) Appl. No.: 17/979,586

(22) Filed: Nov. 2, 2022

Related U.S. Application Data
(60) Provisional application No. 63/278,129, filed on Nov. 11, 2021.

(51) Int. Cl. A01G 9/02

(52) U.S. Cl. CPC A01G 9/028

(57) ABSTRACT

There is described an apparatus and system for the cultivation of plants. The system comprises a floor comprising at least one recess extending below the floor. The system also comprises one or more receptacles. Each receptacle is configured to receive a root system of a plant therein, and further configured to fit into one of the at least recess such that the root system of the plant is located below the floor. Each receptacle comprises a collar and an insert configured to be at least partially received within the collar. Each collar is configured to engage the sides of a recess and each insert is configured to extend below the floor.

### CROSS-REFERENCE TO PREVIOUS APPLICATIONS

This application claims priority from U.S. provisional patent application No. 63/278,129 filed on Nov. 11, 2021, which is incorporated herein by reference in its entirety.

### FIELD

The present disclosure relates to the general field of plant cultivation. In particular, the present disclosure relates to apparatus and systems for the cultivation of plants.

### INTRODUCTION

Indoor cultivation of plants provides a number of benefits. For example, being able to precisely control the lighting conditions, temperature, humidity, carbon dioxide content and ventilation of cultivation spaces allows cultivators in relatively cool climates to grow plants that are native to relatively warmer climates.

There are however a number of disadvantages to indoor cultivation. For example, when plants that are native to warmer climates are grown indoors, they are typically grown in pots. The use of such pots tends to raise the root systems of such plants above the floor level of the cultivation space. Relatively tall plants (such as, for example, trees or cannabis plants) grown in pots which rest on an indoor floor can make them harder for human cultivators to prune and/or pick fruit and flowers therefrom.

Additionally, plants in pots can be unstable and may be inadvertently knocked over. This problem is often compounded by using pots for relatively tall plants which often have relatively higher canopies and centers of gravity.

Moreover, in temperate climates that experience significant seasonal changes, it can be particularly hard to keep indoor cultivation spaces from overheating during warmer months. Thus, when plants are grown in pots located in indoor cultivation spaces, it can be challenging to shield the root systems of such potted plants from excess heat and/or excessively cold temperatures. When the root systems of a plants overheat, the ability of the plants to metabolize sugars can be negatively impacted, which in turn can hamper their ability to yield commercially desirable fruits and flowers.

Furthermore, from a microbiological perspective, there are botanical advantages to providing plants with access to the microbiome of the native soils associated with the geographic areas in which the plants are grown. For example, because plants grown indoors in certain geographic regions will be exposed to the airborne microbiome of that particular geographic region, it can be beneficial to expose the root systems of those same plants to the native soil microbiome of that region. Providing such exposure in an indoor cultivation space using traditional pots can prove to be prohibitively costly and complex.

Accordingly, there is a need for improved apparatus and systems for cultivating plants indoors that do not fall foul of the above disadvantages.

### SUMMARY

The following summary is intended to introduce the reader to various aspects of the applicant's teaching, but not to define any invention.

The various embodiments described herein generally relate to apparatus and systems comprising plant growing receptacles allowing root systems of plants to be located below a floor of a cultivation space. In some embodiments, the plant growing receptacles comprise multiple telescoping parts.

In one aspect of the present disclosure, there is provided an apparatus for the cultivation of plants. The apparatus includes a receptacle that comprises a collar having a first opening, a second opening and at least one collar side wall extending from the first opening to the second opening. The apparatus also includes an insert configured to be at least partially received within the collar. The insert comprises an insert opening, a base and at least one insert side wall extending from the insert opening to the base. A portion of the insert proximate the insert opening is configured to engage a portion of the collar proximate the second opening such that at least part of the insert is prevented from passing through the second opening.

In another aspect of the present disclosure, there is provided a system for the cultivation of plants. The system comprises a floor having at least one recess extending below the floor. The system also comprises one or more receptacles. Each of the one or more receptacles is configured to receive a root system of a plant therein. Each of the one or more receptacles is further configured to fit into one of the at least recess such that the root system of the plant is located below the floor.

In an example of the system, each of the at least one recess comprises an aperture that extends through the floor.

In an example of the system, each of the one or more receptacles comprises a collar having a first opening, a second opening and at least one collar side wall extending from the first opening to the second opening. The receptacle also includes an insert configured to be at least partially received within the collar. The insert comprises an insert opening, a base and at least one insert side wall extending from the insert opening to the base. A portion of the insert proximate the insert opening is configured to engage a portion of the collar proximate the second opening such that at least part of the insert is prevented from passing through the second opening.

### DRAWINGS

The drawings included herewith are for illustrating various examples of apparatus, systems, and processes of the present specification and are not intended to limit the scope of what is taught in any way. In the drawings:

FIG. 1 is a perspective view of a cultivation apparatus in accordance with embodiments of the present disclosure;

FIG. 2 is a side cross-sectional view of a cultivation system in accordance with embodiments of the present disclosure;

FIG. 3 is another side cross-sectional view of a cultivation system in accordance with embodiments of the present disclosure; and

FIG. 4 is a perspective view of a cultivation space including a cultivation system in accordance with embodiments of the present disclosure.

### DESCRIPTION OF VARIOUS EMBODIMENTS

A detailed description of one or more embodiments of the invention is provided below along with accompanying figures that illustrate the principles of the invention. The invention is described in connection with such embodiments, but the invention is not limited to any embodiment. The scope of the invention is limited only by the claims. Numerous specific details are set forth in the following description to provide a thorough understanding of the invention. These details are provided for the purpose of non-limiting examples and the invention may be practiced according to the claims without some or all of these specific details. Technical material that is known in the technical fields related to the invention has not been described in detail so that the invention is not unnecessarily obscured.

The terms “including,” “comprising” and variations thereof mean “including but not limited to,” unless expressly specified otherwise. A listing of items does not imply that any or all of the items are mutually exclusive, unless expressly specified otherwise. The terms “a,” “an” and “the” mean “one or more,” unless expressly specified otherwise.

As used herein and in the claims, two or more parts are said to be “coupled”, “connected”, “attached”, “joined”, “affixed”, or “fastened” where the parts are joined or operate together either directly or indirectly (i.e., through one or more intermediate parts). None of the terms “coupled”, “connected”, “attached”, “joined”, “affixed”, and “fastened” distinguish the manner in which two or more parts are joined together.

As used herein, the term “plant” generally refers to any living organism of the kind exemplified by trees, shrubs, herbs, grasses, ferns, and mosses, typically growing in a permanent site, absorbing water and inorganic substances through its roots, and synthesizing nutrients in its leaves by photosynthesis using the green pigment chlorophyll.

As used herein, the expression “in microbiological communication” generally refers to the ability of the microbiota found in a first medium to migrate and mix in with the microbiota found in a second medium. For example, first and second media that are said to be in microbiological communication have no microbiological barriers preventing the microbiota from the first media from entering the second media, and vice versa.

As used herein, the term “Cannabis” generally refers to a genus of flowering plants that includes a number of species. There are three different species that have been recognized, namely Cannabis sativa, Cannabis indica and Cannabis ruderalis. Hemp, or industrial hemp, is a strain of the Cannabis sativa plant species that is grown specifically for the industrial uses of its derived products. Hemp has lower concentrations of the cannabinoid tetrahydrocannabinol (THC) and higher concentrations of the cannabinoid cannabidiol (CBD), which decreases or eliminates its psychoactive effects.

As used herein, the term “cannabis plant(s)”, encompasses wild type Cannabis and also variants thereof, including cannabis chemovars (or “strains”) that naturally contain different amounts of the individual cannabinoids. For example, some Cannabis strains have been bred to produce minimal levels of THC, the principal psychoactive constituent responsible for the high associated with it and other strains have been selectively bred to produce high levels of THC and other psychoactive cannabinoids. Cannabis plants produce a unique family of terpeno-phenolic compounds called cannabinoids, some of which produce the “high” one experiences from consuming marijuana.

As used herein, the term “cannabis plant material” refers to any part of the plant such as cannabis trim, cannabis flower (also called “cannabis bud”), cannabis kief, or any combination thereof. The plant material can be processed by removing any plant stems. The resulting cannabis material with stems removed can include both flower and trim, only cannabis trim or only cannabis flowers.

As used herein, the term “cannabis trim” generally refers to excess leaves a cultivator trims from the plants. For example, there are two types of leaves that are trimmed from cannabis buds; sugar leaves, which are smaller one-fingered leaves close to the bud, and fan leaves, which are larger multi-fingered leaves. Trimming of the cannabis can occur either before or after harvest of the plants. If done before, the trimming process maximizes the cannabis plant's bloom, yielding more desirable crystals. That is, a good trim will get the grower a bigger, higher quality plant yield. If trimming is carried out post-harvest, the appearance and odor of the buds are improved, and the lower leaf quantity makes the resulting plant matter “smoother” to smoke or vaporize. Because of inherent limitations to existing separation methods, some plant matter or other foreign matter can be present in cannabis trim.

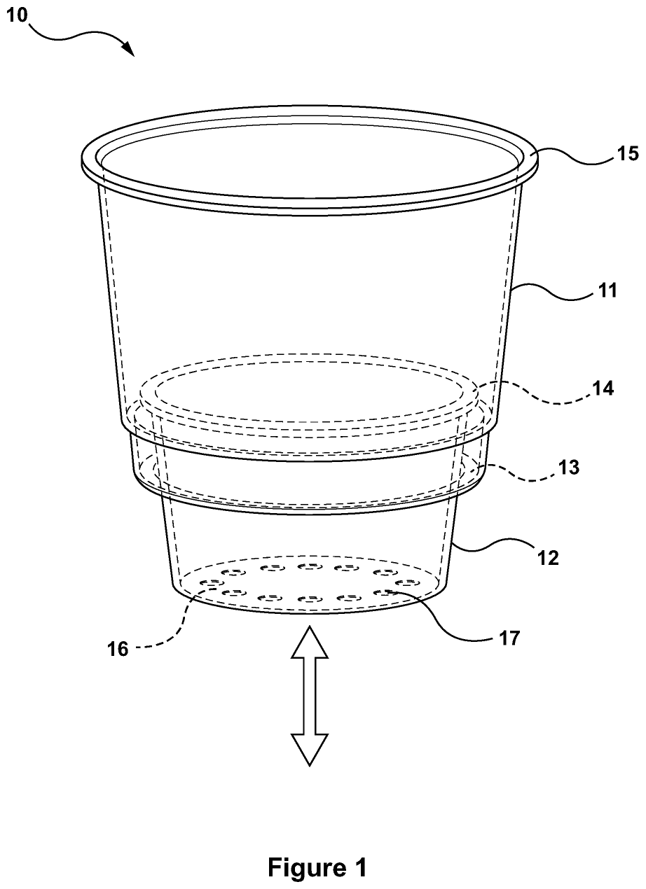

Referring now to the drawing which represent preferred embodiments of the elements of the disclosure, it will be noted that the cultivation apparatus comprises a receptacle 10. In some embodiments, the receptacle 10 comprises a collar 11 and an insert 12. The collar 11 has a top opening and a bottom opening and at least one side wall extending from the top opening to the bottom opening. In some embodiments, and as shown in FIG. 1, the top opening can be larger than the bottom opening. The receptacle 10 also comprises an insert configured to be at least partially received within the collar 11, as shown in FIG. 1. The insert includes a top opening, a base 16 and at least one insert side wall extending from the insert opening to the base 16. The insert 12 is slidably insertable into the collar 11.

In some embodiments, the insert 12 and collar 11 are sized and shaped so as to be telescopically engageable. In other words, the insert 12 is arranged to be received within collar 11 such that it can move along an axis. In some embodiments, the collar 11 and insert 12 are generally circular in cross-section and concentric, the insert 12 being arranged to be received within collar 11 such that it can move along the concentric axes of the collar 11 and insert 12, as shown in FIG. 1.

A portion of the insert 12 proximate its top opening is configured to engage a portion of the collar 11 proximate its bottom opening such that at least part of the insert 12 is prevented from passing through the bottom opening of the collar 11, as shown in FIG. 1.

In some embodiments, the portion of the insert 12 proximate its top opening that is configured to engage the collar 11 is a top part of the external side wall of the insert 12. Similarly, in some embodiments, the portion of the collar 11 proximate its bottom opening that is configured to engage the insert is a bottom portion of the internal wall of the collar 11.

In some embodiments, the top opening of the collar 11 is surrounded by an outwardly projecting flange 15 extending outwardly from the collar side wall, as shown in FIG. 1. In other embodiments, the top rim of collar 11 can be formed in any other suitable way, including inwardly projecting flanges, tapers, or other projections. In some embodiments, the top rim of enlarged diameter will be provided in order to conform with the common configuration of such receptacles.

In some embodiments, the bottom opening of the collar 11 is surrounded by an inwardly projecting flange 13 extending from the at least one collar side wall. In other embodiments, the bottom rim of collar 11 can be formed in any other suitable way, including inwardly projecting flanges, tapers, or other projections.

In some embodiments, the top opening of the insert is surrounded by an outwardly projecting flange 14, extending outwardly from the insert side wall, as shown in FIG. 1. In other embodiments, the top rim of insert 12 can be formed in any other suitable way, including inwardly projecting flanges, tapers, or other projections.

In some embodiments, the portion of the insert 12 proximate its top opening that is configured to engage the collar 11 is the outwardly projecting flange 14 of insert 12. Similarly, in some embodiments, the portion of the collar 11 proximate its bottom opening that is configured to engage the insert is the inwardly projecting flange 13 of collar 11.

The collar 11 and insert 12 may be tapered inwardly from the top to the bottom (e.g., frustoconical in shape), as shown in FIG. 1. Alternatively, the top and bottom sections of collar 11 and insert 12 can be of generally of the same size (e.g., cylindrical in shape).

As will be appreciated by the skilled reader, the side walls of collar 11 and insert 12 can each be formed of a single side wall, forming a single sided shape (e.g., circle or oval) in cross-section, or multiple adjoining side walls, forming a multi-sided shape (e.g., square, star, or triangle) in cross-section. When the side walls of collar 11 and insert 12 are formed of single side walls, some embodiments of collar 11 and insert 12 can be of generally frustoconical in shape. In such embodiments, collar 11 and insert 12 may also be concentric in cross-section. When the side walls of collar 11 and insert 12 are formed of multiple adjoining side walls, some embodiments of collar 11 and insert 12 can be frustopyramidal in shape (e.g., if collar 11 and insert 12 have polygonal cross-sections).

In some embodiments, the base 16 of the insert 12 comprises a flat surface having openings 17, as shown in FIG. 1. The openings 17 can be of any size. For example, the openings 17 may be sized to allow water to flow out from insert 12, but to also retain earth and roots systems therein. In other examples, the openings 17 may be sized to allow parts of the root system of a plant to grow out of the insert 12 and into the soil below, as described in more detail elsewhere herein. In some embodiments, base 16 of insert 12 can comprise a flat closed surface (not shown).

The collar 11 and insert 12 of receptacle 10 can be formed of one or more suitable material, including, but not limited to terracotta, coir, pressed paper, polymer clay, wood, fabrics, clay, polymer, ceramic, fiberglass, concrete, foam, or metal. The collar 11 and insert 12 can be formed of the same material or different materials. In some embodiments, the collar 11 and/or insert 12 can be formed of a suitable polymer including, but not limited to, nylon, acrylic, polycarbonate, polyoxymethylene, polystyrene, acrylonitrile butadiene styrene, polypropylene, polyethylene, thermoplastic polyurethane, and thermoplastic rubber.

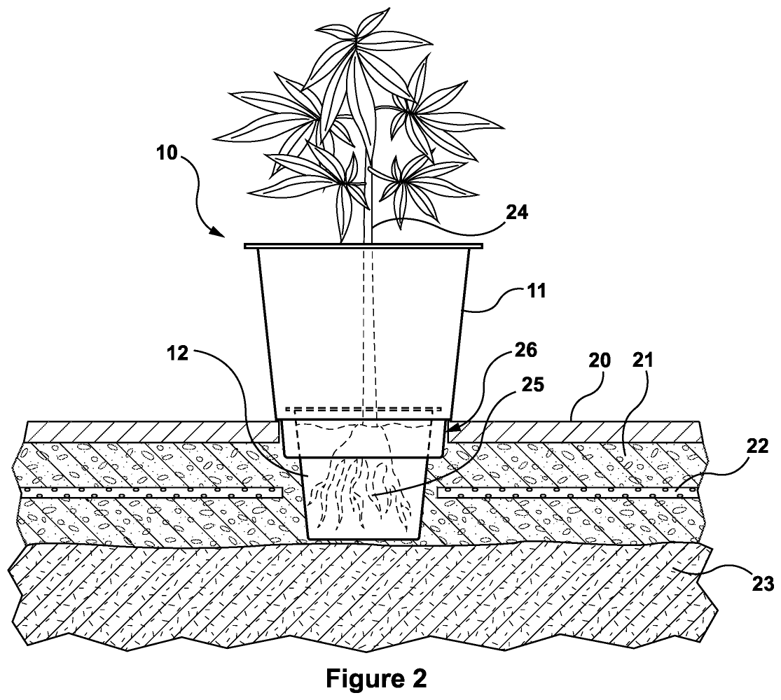

Now, with reference to FIG. 2, examples of the operation of the apparatus and systems disclosed herein will now be described. FIG. 2 shows a system in accordance with the present discloser. The system forms part of an indoor cultivation space. The system comprises a floor 20. The floor 20 can be of any suitable thickness and be formed of any suitable material. In some embodiments, the floor 20 is formed of concrete (e.g., poured concrete). The floor 20 can form part of the structural foundation of the indoor cultivation space. In some embodiments, floor 20 can be formed or partially formed of any suitable material, such as, but not limited to, wood, ceramic, cement, polymer and/or natural or artificial turf. In some embodiments, the floor 20 is formed of a material that provides thermal insulation between the area below the floor 20 and the area above the floor 20.

In some embodiments, a layer of gravel 21 can lay beneath floor 20. Other materials can also be used together with or instead of gravel. Preferably, the material used under floor 20 promotes drainage of water away from floor 20 and thereby reduces hydrostatic pressure on floor 20. In some embodiments, pipes 22 can be embedded in the layer of gravel 21. Pipes 22 can provide underfloor irrigation to indoor cultivation space. Additionally, or alternatively, pipes 22 can provide nutrients, microorganisms and/or substances directed to ensuring pest-control. Additionally, or alternatively, pipes 22 can form part of a Heating, Ventilation and Air Conditioning (HVAC) system for heating and/or coiling the area beneath floor 20. A layer of soil 23 can lay beneath the layer of gravel 21. In some embodiments, the layer of soil 23 is in microbiological communication with the soil surrounding the building in which the indoor cultivation space is housed. In some embodiments, the layer of soil 23 is native to the geographic region in which indoor cultivation space is situated.

The system in accordance with the present disclosure also comprises one or more receptacles 10 as described in more detail elsewhere herein. In some embodiments, receptacles 10 can be received in recessed areas within the floor 20. In some embodiments, such recessed areas can form part of floor 20. In other embodiments, such recessed areas are provided by apertures in floor 20.

As can be seen from FIG. 2, receptacle 10 is sized so as to partially fit through an aperture 26 in floor 20. As such, collar 11 is sized to be press fit into aperture 26. In some embodiments, collar 11 is sized such that the only a portion of the bottom of collar 11 can fit through aperture 26. In some embodiments, as described in more detail elsewhere herein, the system can comprise one or more floors 20 with any number of apertures 26, each sized to receive a corresponding receptacle 10. As will be appreciated by the skilled reader, shielding a plant's root system from excessively cold temperatures can also be beneficial.

The system shown in FIG. 2 can be provided by first cutting an aperture 26 into floor 20. Alternatively, aperture 26 can be molded using a mold and, for example, poured concrete. Once aperture 26 is provided, a space can be created below aperture 26 by, for example, remove gravel 21 and/or soil 23 below aperture 26. Once a space is created below aperture 26, collar 11 can be inserted and press fit into aperture 26. Then, once collar 11 is securely in place, insert 12 can be slidably engaged within collar 11, as shown in FIG. 2. Soil can then be added to the receptacle and plant 24 can be planted therein in the normal manner.

As can be seen from FIG. 2, a plant 24 can be planted in receptacle 10. When planted, the system is configured to ensure that the root system 25 of plant 24 is generally located below the level of floor 20. In some embodiments, a majority of the collar 11 is located above floor 20 and a majority of insert 12 is located below floor 20. As such, the root system can be protected from excessive heat located above floor 20. As will be appreciated by the skilled reader, shielding a plant's root system from excessive heat can promote their capacity to metabolize sugars, which in turn can increase their ability to yield commercially desirable fruits and flowers. This feature is particularly desirable in indoor cultivation spaces that have artificial lighting, which can significantly increase temperatures of the indoor cultivation space during warmer periods of the year.

As can also be seen from FIG. 2, the root system 25 of plant 24 can also be brought into proximity with soil layer 23 located below the indoor cultivation space. This can produce significant botanical benefits to the plant 24, notably with respect to exposing the plant 24 to the microbiome native to the surrounding soil 23.

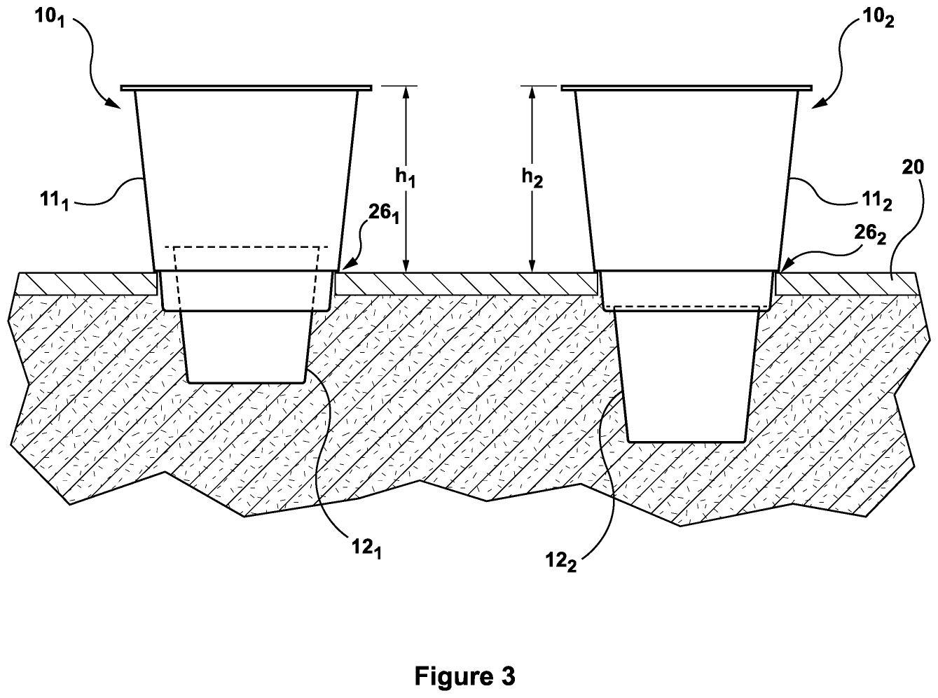

With the foregoing description of the structural and mechanical details of the systems and apparatus described herein in view, the method of operation will be obvious to the skilled reader but is briefly set out below with reference to FIG. 3 for the avoidance of doubt. FIG. 3 shows a system in accordance with the present disclosure comprising a floor 20, as described elsewhere herein, a first receptacle 101, and a second receptacle 102. Receptacle 101 comprises a collar 11₁ and an insert 12₁, as described in more detail elsewhere herein. Similarly, receptacle 101 comprises a collar 11₁ and an insert 12₁, as described in more detail elsewhere herein.

As can be seen from FIG. 3, the ground below floor 20 of the indoor cultivation space may not be even. In particular, there may be more space between the soil and the floor 20 below some apertures than there is below other apertures. On significant advantage of the apparatus and systems described herein is that because the collar 11 is shaped and sized in order to engage with the sides of the aperture 26, and that insert 12 is telescopically engageable within collar 11, the base 16 of insert 12 can accommodate different distances between the soil and the floor 20, without affecting the position of the collar 11. In other words, the position of the top of the collar h is determined by the size and shape of the collar 11 and the size and shape of the aperture 26, as opposed to the amount of soil located below aperture 26. This provides notable advantages to cultivators.

For example, soil beneath each aperture 26 needs to be removed to provide a space for receptacle 10 to be received under floor 20. It can therefore be challenging to provide the exact same amount of space beneath each aperture 26. As shown in FIG. 3, more soil has been removed below aperture 26₂ than below aperture 26₁. Because however inserts 12ₓ are telescopically engageable within collars 11ₓ, and collars 11ₓ are held in place by way of their engagements with the sides of apertures 26ₓ, each of insert 12₁ and insert 12₂ can slide downwardly along the inside of collar 11₁ and collar 11₂, respectively, such that they both fill the space provided below aperture 26₁ and aperture 26₂, without affecting the position of collar 11₁ and collar 11₂ with respect to the floor 20. Thus, regardless of how deep the space is between each aperture 26ₓ, the height of the top rim of each collar 11ₓ will remain unchanged (i.e., h₁=h₂).

Moreover, because the root system 25 of plant 24 is under floor 20, the canopy of the plant 24 will be lower than is the plant was planted in a pot that stood on floor 20. Finally, because the position of receptacle 10 is dictated by the position of its corresponding aperture 20, the location of receptacle 10 on floor 20 can be tightly controlled and plants can be held firmly upright. Dissimilarly, when plants are planted in pots that simply sit on a floor, those pots can often easily be moved along the floor and/or tipped over, leading to plant damage and/or uneven spacing between plants, which can, for example, negatively affect pest control and ventilation. Furthermore, providing plant canopies that are closer to floor 20 allows for easier pruning, trimming, and harvesting of such canopies.

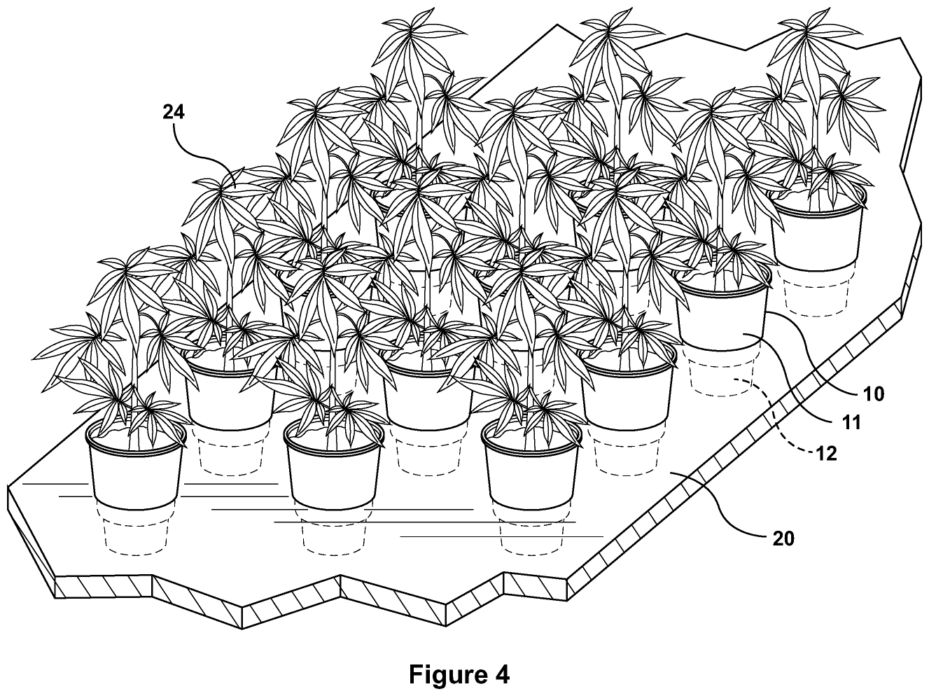

FIG. 4 is a perspective view of an indoor cultivation space including a cultivation system in accordance with embodiments of the present disclosure. As can be seen from FIG. 4, each receptacle 10 is press fit into a corresponding aperture in floor 20, with a majority of collar 11 being located above floor 20 and a majority of insert 12 being located below floor 20. This allows for even and secure spacing between plants, shielding of roots systems from any excessive heat that might be present within the indoor cultivation space and pant canopies being positioned at relatively closer to floor 20, thereby providing several of the technical advantages set out in more detail elsewhere herein.

While the above description provides examples of the embodiments, it will be appreciated that some features and/or functions of the described embodiments are susceptible to modification without departing from the spirit and principles of operation of the described embodiments. For example, while the above apparatus and systems have been described with respect to indoor cultivation spaces, the apparatus and systems of the present disclosure can also be applied mutatis mutandis to outdoor cultivation spaces being provided with floor surfaces. Accordingly, what has been described above has been intended to be illustrative of the invention and non-limiting and it will be understood by persons skilled in the art that other variants and modifications may be made without departing from the scope of the invention as defined in the claims appended hereto. The scope of the claims should therefore not be limited by the preferred embodiments and examples, but should be given the broadest interpretation consistent with the description as a whole.

1. An apparatus for the cultivation of plants, the apparatus including a receptacle comprising:
a collar having a first opening, a second opening and at least one collar side wall extending from the first opening to the second opening; and
an insert configured to be at least partially received within the collar, the insert comprising an insert opening, a base and at least one insert side wall extending from the insert opening to the base,
wherein a portion of the insert proximate the insert opening is configured to engage a portion of the collar proximate the second opening such that at least part of the insert is prevented from passing through the second opening.

2. The apparatus of claim 1, wherein the first opening is surrounded by an outwardly projecting collar flange extending from the at least one collar side wall.

3. The apparatus of claim 2, wherein the insert opening is surrounded by an outwardly projecting insert flange extending from the at least one insert side wall.

4. The apparatus of claim 3, wherein the second opening is surrounded by an inwardly projecting collar flange extending from the at least one collar side wall.

5. The apparatus of claim 4, wherein the portion of the insert proximate the insert opening includes the outwardly extending insert flange.

6. The apparatus of claim 5, wherein the portion of the collar proximate the second opening includes the inwardly extending collar flange.

7. The apparatus of claim 1, wherein the portion of the insert proximate the insert opening includes one or more portions of the at least one insert side wall.

8. The apparatus of claim 1, wherein the portion of the collar proximate the second opening includes one or more portions of the at least one collar side wall.

9. The apparatus of claim 1, wherein the first opening is larger than the second opening and the insert opening is larger than the base.

10. The apparatus of claim 1, wherein the at least one insert side wall consists of a single side wall and the at least one collar side wall consists of a single side wall.

11. The apparatus of claim 10, wherein the collar and the insert are generally concentric and frustoconical in shape.

12.-17. (canceled)

18. The apparatus of claim 1, wherein the insert opening is larger than the second opening.

19. The apparatus of claim 1, wherein the collar and the insert are telescopically engageable.

20. The apparatus of claim 1, wherein the plants are cannabis plants.

21. A system for the cultivation of plants, the system comprising:
a floor comprising at least one recess extending below the floor; and
one or more receptacles, each configured to receive a root system of a plant therein, and further configured to fit into one of the at least recess such that the root system of the plant is located below the floor.

22. The system of claim 21, wherein each of the at least one recess comprises an aperture that extends through the floor.

23. The system of claim 22, wherein the floor is located above a layer of soil.

24. The system of claim 23, wherein the soil is in microorganic communication with outdoor soil.

25. The system of claim 24, wherein the system is configured such that, each of the one or more receptacles extends to the layer of soil when fit into a respective aperture.

26.-31. (canceled)

32. The system of claim 21, wherein the one or more receptacles comprises
an apparatus in accordance with claim 1.

33-52. (canceled)
